(19) United States
(12) Patent Application Publication
(10) Pub. No.: US 2016/0117649 A1
(43) Pub. Date: Apr. 28, 2016

(54) PAYMENT PROCESSING SYSTEM AND METHOD FOR PURCHASING REGULATED GOODS

(71) Applicant: Sylvain Desrosiers, Las Vegas, NV (US)

(72) Inventor: Sylvain Desrosiers, Las Vegas, NV (US)

(21) Appl. No.: 14/921,606

(22) Filed: Oct. 23, 2015

Related U.S. Application Data
(60) Provisional application No. 62/067,499, filed on Oct. 23, 2014.

(51) Int. Cl. G06Q 20/04; G06Q 20/20

(52) U.S. Cl. CPC G06Q 20/0453; G06Q 20/209; G06Q 20/203

(57) ABSTRACT

A system for processing payment of regulated goods includes a computer-based manager configured with databases for storing data relative to a user's eligibility to purchase regulated goods, data relative to vendor inventory of regulated goods, data relative to vouchers requested by such user. Such system further includes a remote system in communication with the manager through which a user may request a voucher and pay for the regulated goods after which a voucher is generated by the remote system. A vendor system verifies the validity of the generated voucher and provides inventory data to the manager upon dispensing of the regulated goods to the verified user.

### CROSS-REFERENCE TO RELATED APPLICATIONS

This application claims the benefit of priority of U.S. Prov. App. No. 62/067,499, filed Oct. 23, 2014, and which is incorporated by reference as if fully set forth herein.

### BRIEF DESCRIPTION OF THE DRAWINGS

The system and method is described below with reference to the accompanying drawings. In the drawings, like reference numbers indicate identical or functionally similar elements. Additionally, the left-most digit(s) of a reference number identifies the drawing in which the reference number first appears.

FIG. 1 is an exemplary network architecture of the inventive system set forth herein;

FIG. 2 is an exemplary module relationship diagram;

FIG. 3 is an exemplary computer-based device;

FIG. 4 is an exemplary kiosk for use in the system; and

FIG. 5 is a flow chart of an exemplary process for generating a user voucher for purchasing regulated goods;

FIG. 6 is a flow chart of an exemplary process for verifying a voucher presented to a vendor; and

FIG. 7 is a relational diagram of another exemplary embodiment of the system.

### DETAILED DESCRIPTION

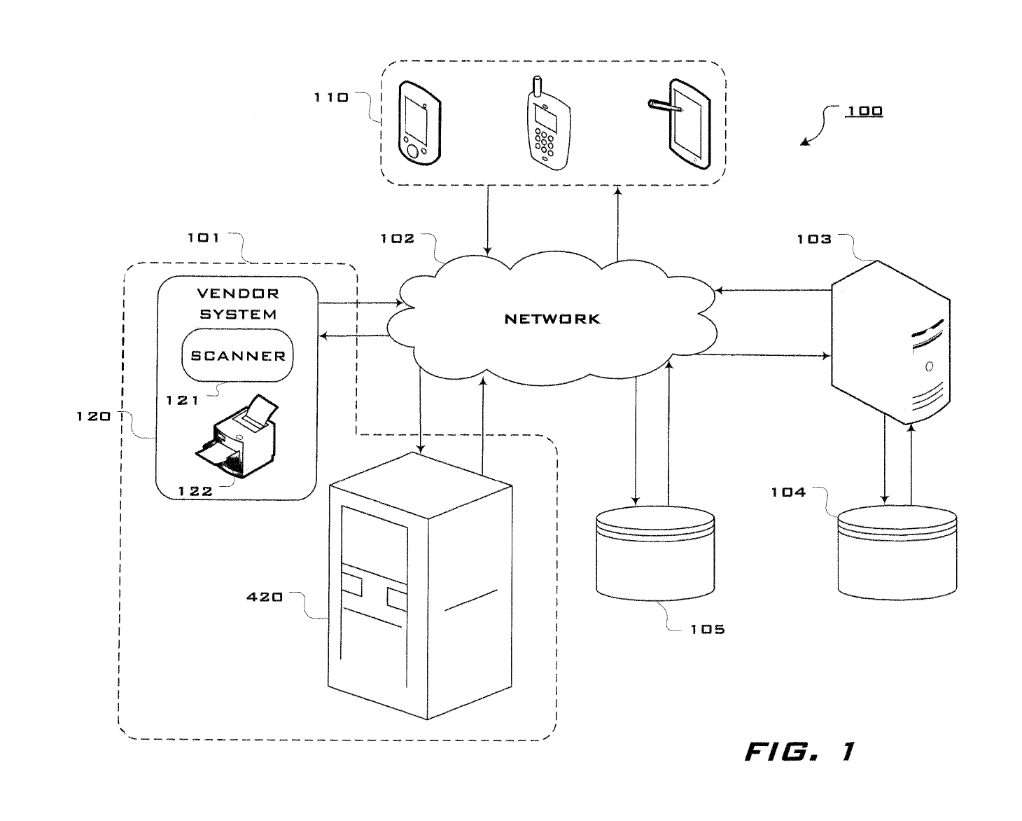

The various embodiments of the system and method and their advantages are best understood by referring to FIGS. 1 through 7 of the drawings. The elements of the drawings are not necessarily to scale, emphasis instead being placed upon clearly illustrating the novel features and principles of operation. Throughout the drawings, like numerals are used for like and corresponding parts of the various drawings.

Furthermore, reference in the specification to “an embodiment,” “one embodiment,” “various embodiments,” or any variant thereof means that a particular feature or aspect described in conjunction with the particular embodiment is included in at least one embodiment. Thus, the appearance of the phrases “in one embodiment,” “in another embodiment,” or variations thereof in various places throughout the specification are not necessarily all referring to its respective embodiment.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “providing”, “forwarding”, “receiving”, “performing”, “comparing”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed system also relates to apparatuses for performing the operations herein. These apparatuses may be specially constructed for the required purposes, or may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

A computer may be any microprocessor or processor (hereinafter referred to as processor) controlled device, such as, by way of example, personal computers, workstations, servers, clients, mini-computers, main-frame computers, laptop computers, a network of one or more computers, mobile computers, portable computers, handheld computers, palm top computers, interactive kiosks, personal digital assistants, interactive wireless devices, mobile browsers, or any combination thereof. The computer may possess input devices such as, by way of example, a keyboard, a keypad, a mouse, a microphone, or a touch screen, and output devices such as a computer screen, printer, or a speaker.

The computer may be a uniprocessor or multiprocessor machine. Additionally, the computer includes memory such as a memory storage device or an addressable storage medium. The memory storage device and addressable storage medium may be in forms such as, by way of example, a random access memory (RAM), a static random access memory (SRAM), a dynamic random access memory (DRAM), an electronically erasable programmable read-only memory (EEPROM), a programmable read-only memory (PROM), an erasable programmable read-only memory (EPROM), hard disks, floppy disks, laser disk players, digital video disks, compact disks, video tapes, audio tapes, magnetic recording tracks, electronic networks, and other devices or technologies to transmit or store electronic content such as programs and data.

The computer executes an appropriate operating system such as Linux, Unix, Microsoft® Windows® 95, Microsoft® Windows® 98, Microsoft® Windows® NT, Apple® MacOS®, IBM® OS/2®, iOS, and the like. The computer may advantageously be equipped with a network communication device such as a network interface card, a modem, or other network connection device suitable for connecting to one or more networks.

The computer, and the computer memory, may advantageously contain program logic or other substrate configuration representing data and instructions, which cause the computer to operate in a specific and predefined manner as, described herein. The program logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like.

The program logic conventionally includes the manipulation of data bits by the processor and the maintenance of these bits within data structures resident in one or more of the memory storage devices. Such data structures impose a physical organization upon the collection of data bits stored within computer memory and represent specific electrical or magnetic elements. These symbolic representations are the means used by those skilled in the art to effectively convey teachings and discoveries to others skilled in the art.

The program logic is generally considered to be a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for computer operations, and that these terms are merely conventional labels applied to physical quantities that exist within and during operation of the computer.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hard-wired logic or programs stored in nonvolatile memory, such as, by way of example, read-only memory (ROM).

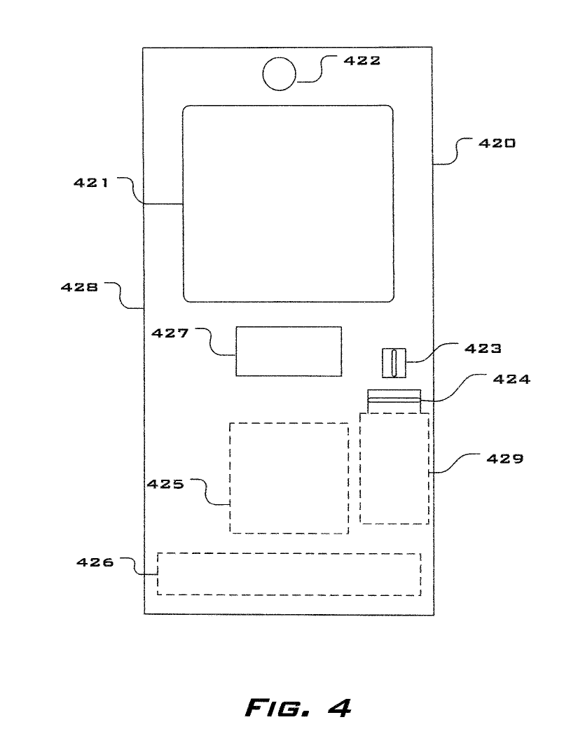

Referring first to FIG. 4, a kiosk 420 for use with the system is illustrated including a housing 428 that houses a kiosk processor 426 and a kiosk printer 425. The kiosk 420 also includes a display 421 responsive to the processor 426. Display 421 is preferably a touch-sensitive screen through which input from a user may be first elicited through a graphic user interface (GUI) and then input by the user by touching the screen appropriately. Kiosk 420 further includes a voucher dispenser 427 that allows a user to retrieve a voucher printed by the printer 425, a card reader 423 and a cash intake 424. Cash intake 424 is operable to receive a cash payment from a user, by coins or bills, and may advantageously be configured to validate the authenticity of the cash being inserted. Further, cash intake 424 forwards received cash to a safe 429 securely housed within the housing 428. Card reader 423 may be any reader or scanner of cards that include computer-readable data which, for example, represent user identification, user financial information (or permissions to access such financial information). Card reader 423 and cash intake 424 are likewise responsive to the processor 426. Kiosk 420 also preferably includes an optical sensor 422, responsive to the processor 426, which is configured to detect optical images in the space confronting the kiosk 420. Optical sensor 422 such as a video or still camera, captures images for biometric and demographic analysis. An optional but preferred auxiliary input device such as a keypad, touchpad (not shown) or the like allows for user input to augment or supplement touch commands on the screen.

Referring now to FIG. 1, a payment processing system for the purchase of regulated goods 100 comprises a remote kiosk 420 that is associated with a vendor 101 of regulated goods. As used herein, “regulated goods” refers to goods the dispensing and purchase of which are regulated by a government entity. Typically, such goods may only be purchased by users with a valid license to do so, for example and without limitation, alcoholic beverages and cigarettes, as well as other government-regulated products, including medicaments. Government regulations typically require a vendor 101 to verify that prospective purchasers of regulated goods possess such a valid license.

Vendor 101 also includes a vendor system 120 that comprises a processing system that controls a scanner 121 and a printer 122. Both the vendor system 120 and the kiosk 420 are configured to access, transmit data and retrieve data from a communications network 102 which may be a private network (e.g., a local area network (LAN), wide area network (WAN), intranet, etc.) or a public network (e.g., the internet). A manager, or application server, 103 may also be in communication with network 102 and, likewise a plurality of remote, mobile devices 110. In addition, manager 103 is configured to access a database 104 configured as will be described in detail below.

Manager 103 may provide one or more services (e.g., database services, systems management services, network monitoring services, transactional services, webpage viewing services, etc.) to kiosk 420 or mobile devices 110. Manager 103 may be a front end server and/or a back end server. Through the manager 103, users of kiosk may request data, initiate actions, receive information, etc., via application service requests.

In one embodiment, manager 103 is a web application server, and is configured with an application that receives an application service request entered by a user from the kiosk 420 or a remote device 110. Based on the contents of the request, manager 103 may determine that web application should perform one or more actions, after which manager 103 may return an application service response to the kiosk. For example, the web application provides through an application response comprising validation of data entered from the kiosk 420, feedback relating to invalid data or attempts to enter impermissible data, and data structure information retrieval and display services.

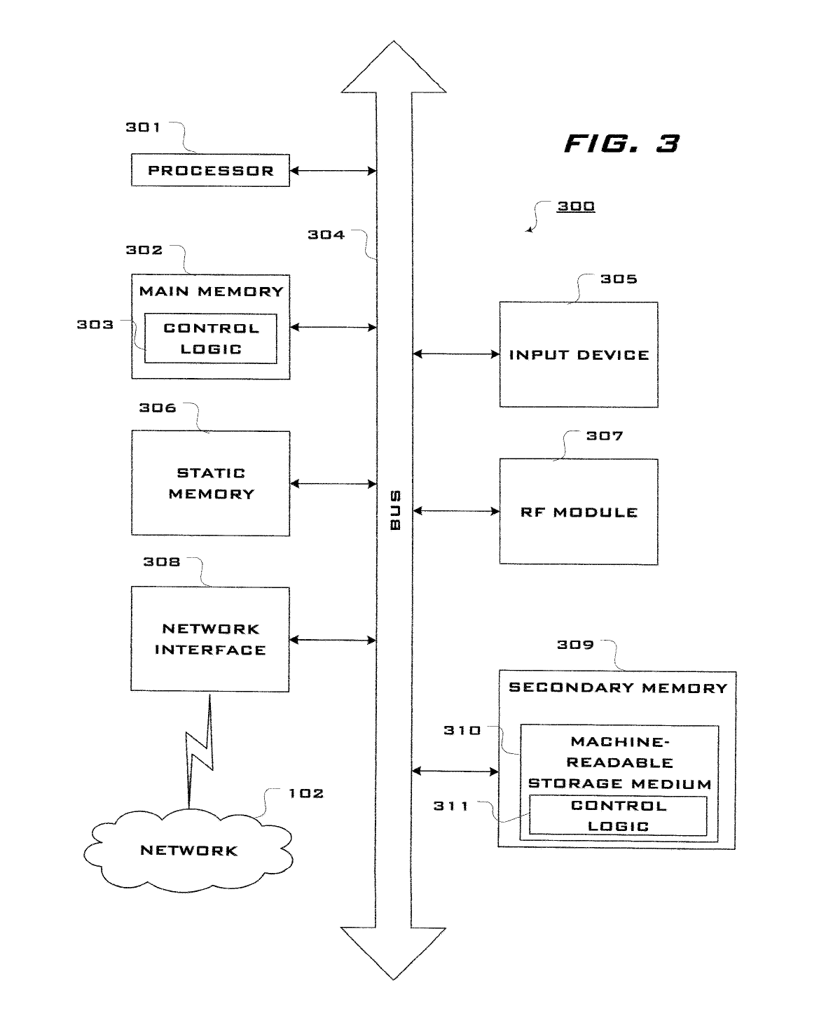

FIG. 3 illustrates a diagrammatic representation of a machine in the exemplary form of a computer system 300 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 300 includes a processor 301 and a main memory 302 (e.g., read-only memory (ROM), flash memory, dynamic random access memory (DRAM) such as synchronous DRAM (SDRAM) or Rambus DRAM (RDRAM), etc. Computer system 300 may also include a static memory 306 (e.g., flash memory, static random access memory (SRAM), etc.), and a secondary memory 309 (e.g., a data storage device), which communicate with each other via a communication bus 304.

Processor 302 represents one or more general-purpose processing devices such as a microprocessor, central processing unit, or the like. More particularly, the processor 302 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 302 may also be one or more special-purpose processing devices such as an application specific integrated circuit (ASIC), a field programmable gate array (FPGA), a digital signal processor (DSP), network processor, or the like.

The computer system 300 may further include a network interface device 308. The computer system 300 also may include a computer interface 305 comprising output device, such as a display (e.g., touch-responsive screen, a light-emitting diode (LED) display, a liquid crystal display (LCD) or a cathode ray tube (CRT)), and an input device (e.g., a keyboard, or microphone).

The secondary memory 309 may include a machine-readable storage medium (or more specifically a computer-readable storage medium) 310 on which is stored one or more sets of instructions (e.g., control logic 311) embodying any one or more of the methodologies or functions described herein. The control logic 311 may also reside, completely or at least partially, within the main memory 302 during execution thereof by the computer system 300, the main memory 302 and the processing device 301 also constituting machine-readable storage media. The control logic 311 may further be transmitted or received over a network 320 via the network interface device 308.

While the machine-readable storage medium 310 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the system and method. The term “machine-readable storage medium” shall accordingly be taken to include, but not be limited to, solid-state memories, and optical and magnetic media.

Control logic 311 (also called computer programs or software) is stored in the main memory and/or secondary memory. Control logic 311 can also be received via the communications interface. Such control logic, when executed, enables the computer system to perform certain features of the system and method as discussed herein. In particular, the control logic, when executed, enables a control processor to perform and/or cause the performance of features of the system and method. Accordingly, such control logic 311 represents controllers of the computer system.

The processor 301, and the processor memory, may advantageously contain control logic 311 or other substrate configuration representing data and instructions, which cause the processor to operate in a specific and predefined manner as, described hereinabove. The control logic 311 may advantageously be implemented as one or more modules. The modules may advantageously be configured to reside on the processor memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like. Control logic 311 may be installed on the memory using a computer interface coupled to the communication bus which may be any suitable input/output device. The computer interface may also be configured to allow a user to vary the control logic, either according to pre-configured variations or customizably.

The control logic 311 conventionally includes the manipulation of data bits by the processor and the maintenance of these bits within data structures resident in one or more of the memory storage devices. Such data structures impose a physical organization upon the collection of data bits stored within processor memory and represent specific electrical or magnetic elements. These symbolic representations are the means used by those skilled in the art to effectively convey teachings and discoveries to others skilled in the art.

The control logic 311 is generally considered to be a sequence of processor-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for processor operations, and that these terms are merely conventional labels applied to physical quantities that exist within and during operation of the computer.

It should be understood that manipulations within the processor are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the processor or computers.

It should also be understood that the programs, modules, processes, methods, and the like, described herein are but an exemplary implementation and are not related, or limited, to any particular processor, apparatus, or processor language. Rather, various types of general purpose computing machines or devices may be used with programs constructed in accordance with the teachings described herein.

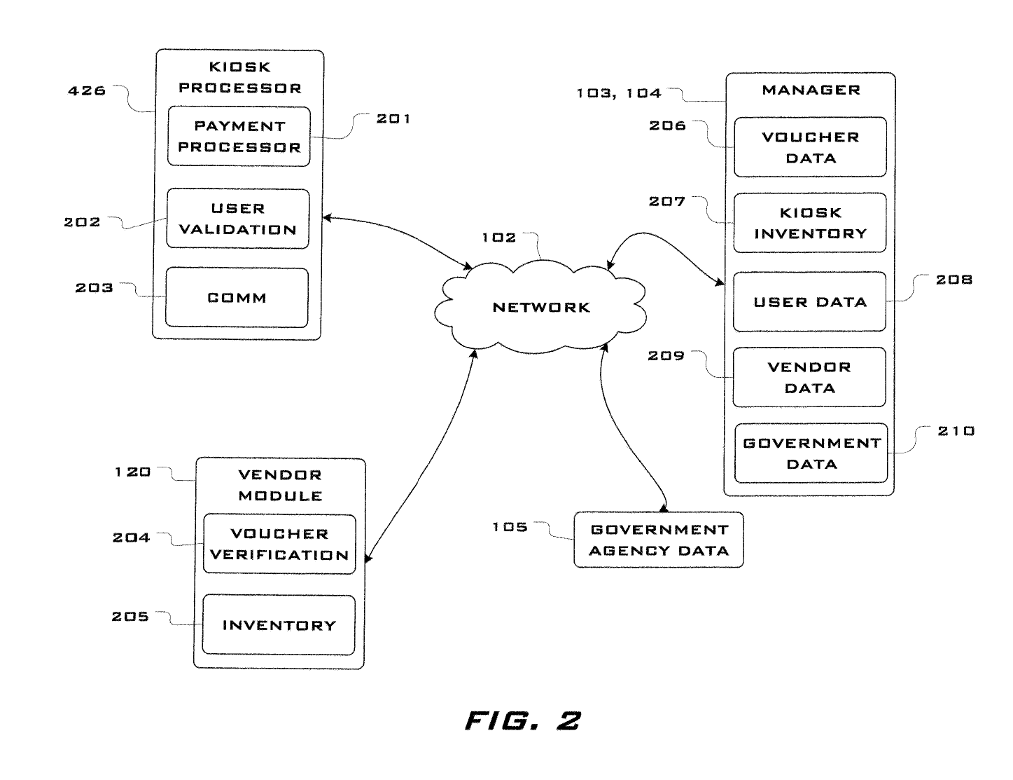

With this mind, and referring now to FIG. 2, the system may also be considered in a functional module form, designating various modules of control logic 311. The functions of these modules will become clear hereafter in describing the processes performed by the system 100. Kiosk processor 426 may be configured with, in an embodiment, a payment processor module 201, a user validation module 202 for executing validation of user identity and eligibility data, and a communication module 203 for coordinating transmission and reception of data to and from the manager 103 via the network 102. The vendor system 120 is the component that is used by a licensed vendor 101 operator and includes, at least, a voucher verification module 204 which controls receipt of data from the scanner 121, and communicates voucher information to the manager 103. Vendor system 120 may also be configured with an inventory module 205 that maintains vendor inventory data based upon transactions executed by through system. Inventory data may also be transmitted to the manager 103.

Turning now to the manager 103, also labeled here as “Kiosk management,” it will be understood that the manager 103 may be configured to access a separate computer-based device that is configured with the necessary databases (FIG. 1: 104), or the server 103 may be configured with the required database functionality as mentioned above. In either case, for ease of reference the server 103 may be understood to include the database 104 unless otherwise noted. Server 103 is preferably configured with a user data module 208 that stores data regarding users legally permitted to purchase regulated goods and is configured to retrieve such data, for example, identification, driver's license, regulated goods license data, etc., in response to requests from the kiosk 420 system. Optionally, user data 208 could include user consumption data, especially advantageous in circumstances in which users may be limited in the dosage of regulated goods that may be consumed under applicable license rules. To the extent practicable, user data 208 may be configured to access any available user records maintained by relevant government agencies through the network 102 where such records may be stored in government agency databases 105. In addition, a government data module 210 may be configured to obtain regulatory information from such database 105.

Manager 103 is also preferably configured with a voucher data module 206 which generates a unique voucher data in response to a validated request for a transaction from a user through a kiosk 420 (further described below), stores such voucher data, and transmits voucher data to the kiosk 420 for issuance to a user. The voucher data module 206 would also receive scanned voucher data received from the vendor system 120 voucher verification module 204 and to compare that scanned voucher data to stored voucher data. Vendor data module 209 obtains merchant data, e.g., vendor licenses, identification numbers, geolocations, and inventory data. This module 209 may also be configured to report inventory data upon request of applicable government authority. Finally, a kiosk inventory module 207 may be installed on the server 103 to maintain data relevant to each the plurality of remote kiosks 420 in the systems.

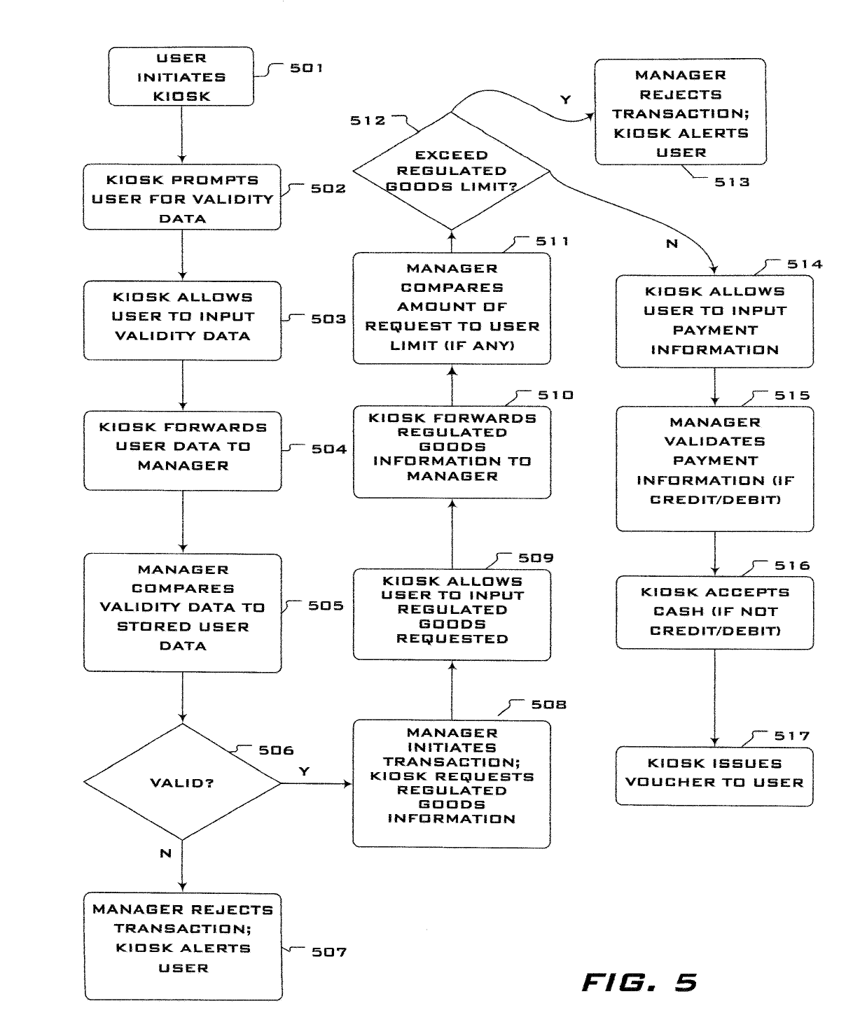

An exemplary process executed by the system 100 for a user transaction is illustrated in FIG. 5, beginning when the user starts kiosk 420 operation at step 501, in response to which the kiosk 420 prompts the user for validity data, step 502. Validity data could be in a variety of forms depending on legal or regulatory restrictions in which the system 100 is deployed, but essentially include data representative of eligibility to purchase regulated goods within the relevant jurisdiction. The kiosk 420, appropriately configured with control logic 311 described above, then allows the user to input validity data in a variety of ways at step 503. For example, the validity data may simply be responses to a series of questions that, for example, anonymously verify a user has a valid driver's license, a valid regulated goods license, and is over the relevant legal age to purchase regulated goods. Of course, it may then be incumbent upon the vendor operator to manually insure the user has answered such questions truthfully if local vendor licensing restrictions penalize vendor if product is sold to non-eligible users.

Alternatively, validity data would be in a form retrievable from a driver's license card, or other valid identification, and a valid regulated goods license card. In this case, identification and regulated goods license data may electronically embedded in the respective cards, and the kiosk 420 may use a card reader 423 configured to scan the cards and retrieve the data therefrom. It will be appreciated that validity data may also be manually input into the kiosk 420 through the display 421 and an interactive “virtual keypad”, or conventional electromechanical keypad. In either case, it will be appreciated that electronic input of user validity data allows tracking of user consumption and relieves the vendor operator from the burden of constantly checking for disingenuous users.

Upon entry of the validity data, the kiosk 420 forwards the data 504 to the manager 103, which then compares the input validity data to stored user data 505. A return of “invalid” at step 506 would cause the server 103 to reject the transaction at step 507, transmitting such rejection to the kiosk 420, which would alert the user. On the other hand, if the data is valid at step 506, the server 103 initiates the transaction, cueing the kiosk to request information from the user regarding the desired regulated goods 508, e.g., type, in some cases, more importantly, the amount. The kiosk is configured to allow the user input a response to this prompt at 509 and such response is forwarded to the server 103 at step 510. In cases where there is a dosage limit as mentioned above, the server compares the requested amount of regulated goods to be purchased in the transaction to the stored user data 512 which could include the user's consumption to date. If the requested amount exceeds the user's limit (step 513), the server 103 rejects the transaction and the kiosk 420 appropriately alerts the user 514. Otherwise, the transaction continues and the kiosk prompts the user to input payment information 515. The kiosk 420 forwards such payment information to the server 103 which, in case the user desires to pay electronically (credit or debit card, for example), the server 103 executes the appropriate payment actions, i.e., withdrawal from the user's debit account or requests for payment from the credit company. If the user elects to pay with cash, the kiosk 420 is configured to locally receive cash 517 through the cash intake 424. In either case, upon completion of the payment, the server 103 voucher data module 206 generates a unique voucher data packet which includes the user identification, the requested dosage purchased, the payment information, and represents that the voucher was issued to a user legally permitted to purchase regulated goods. This voucher data is sent to the kiosk which prints this data onto a card, preferably in a machine-readable format and dispenses this card to the user 518. It will be appreciated that the function of generating the unique voucher data could be performed at the local kiosk 420 and then later transmitted to the server 103 for storage and comparison.

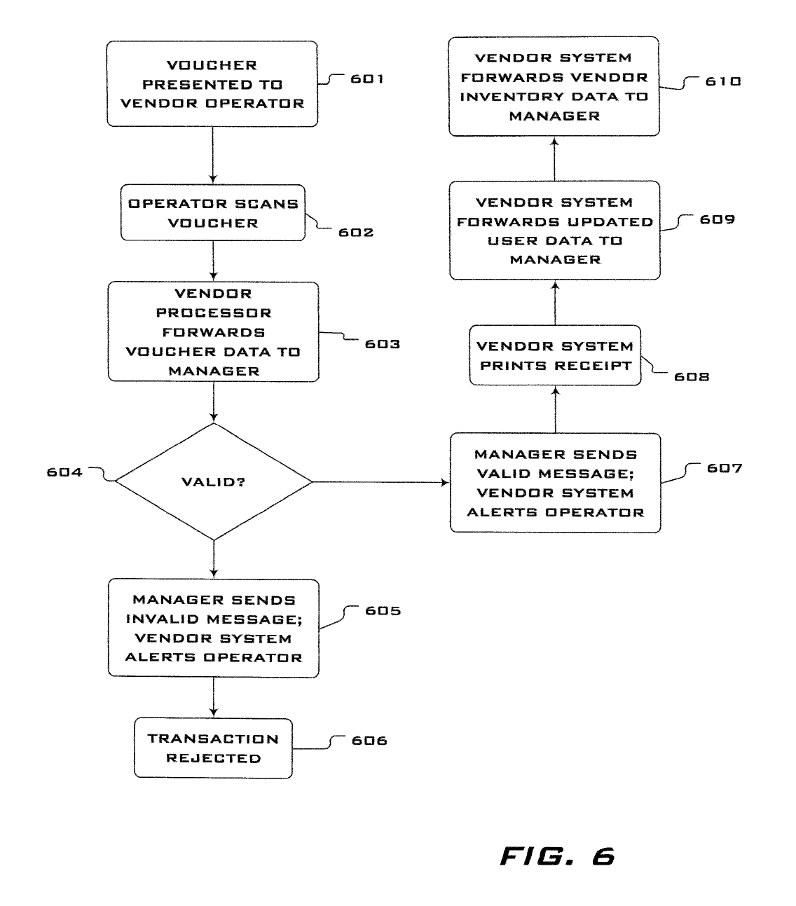

With reference now to FIG. 6, when the user desires to purchase the regulated goods, the user presents the voucher to the operator of the vendor 601, who then scans the voucher 602 with the scanner 121. Scanner 121 is configured to allow the vendor system 120 to read the unique data imprinted on, or embedded in, the voucher that indicates the voucher is valid and also may indicate the identity of the user presenting the voucher. The user may also present identification as well. In a further embodiment, the scanner 121 and the vendor system 120 are configured to read data that may be imprinted on or embedded in user government-issued identification cards as well.

At step 603, the vendor system 120 forwards the scanned voucher information to the manager 103, which, using the voucher data module 206 described above, assesses whether the voucher is valid 604. If the voucher is invalid, the application server issues a message to the vendor system 120 accordingly which then alerts the vendor operator 605, and the transaction is rejected 606.

Otherwise, the manager 103 issues a valid voucher message to the vendor system 120, which then alerts the operator appropriately 607. The vendor system 120 prints a receipt 608 via printer 122, and forwards updated user data and updated vendor inventory data to the application server 609, 610.

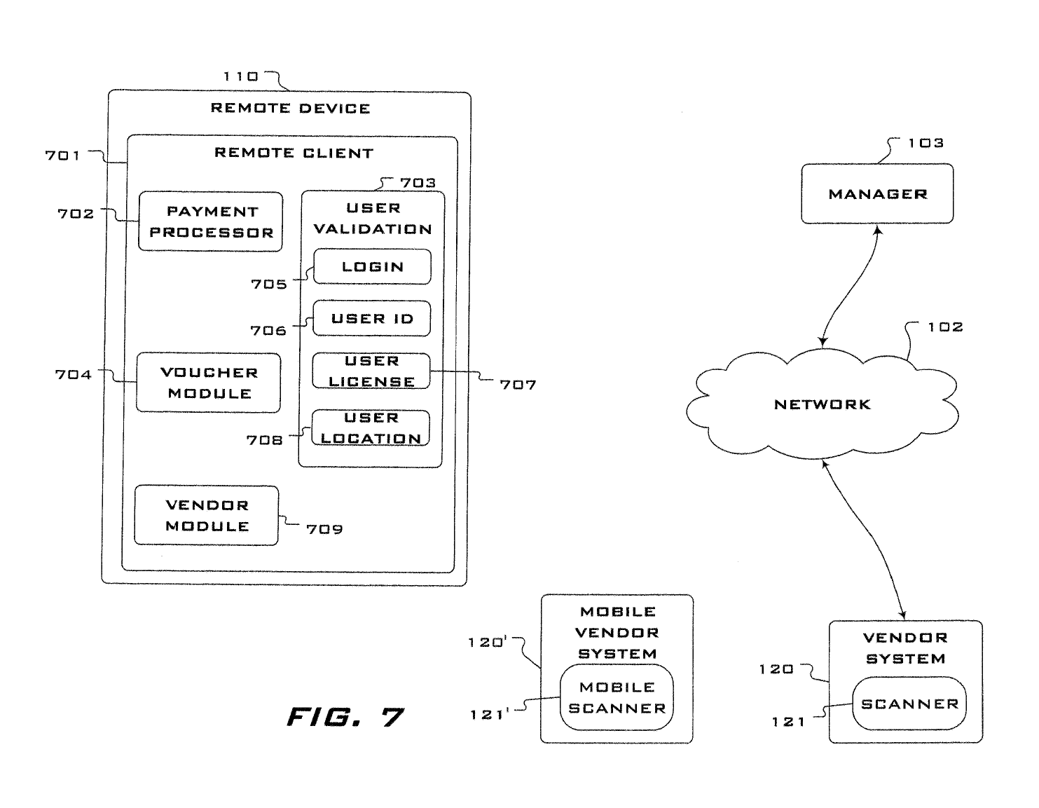

Another exemplary embodiment of the system 100, includes, as described above, a remote device 110. Such a mobile device may be a personal computer (PC), a tablet computer, a smart phone, or any computer-based device capable of transmitting and receiving data via the network 102, storing and displaying data to a user. In the embodiment shown in FIG. 7, a mobile device may be configured with control logic 311 that represents a remote client 701 specifically designed to interact with manager 103 across the network 102. Remote client 701 may include a user validation module 703 comprising a user login module that stores user secure login data (e.g., username, password, or other code) and executes secure login procedures. The user validation module 703 may further include a user identification module 706 which stores user identification data, including a government issued identification (e.g., driver's license), and a medical regulated goods license module 707 which stores user regulated goods license data. These identification and license data may be in the form of photo images of the respective licenses, for example. Additionally, the user validation module 703 may include a user location module 708 which may be configured to access remote device 110 location information and store such information.

The remote client 701 may also be configured with a payment processor module 702 that stores user bank or credit/debit card information, or information relating to electronic money transfer services that may be used by the user via the remote device 110 (e.g., PayPal®). A voucher module 704 may execute virtual voucher generation, explained in greater detail below. The remote client 701 may also include a vendor module 709 which stores and presents information relating to dispensaries 120 in the vicinity of the mobile device, and vendor product information.

In operation, a user desiring to purchase regulated goods via the remote device 110 may launch the remote client 701 according to the mobile device's 110 operating system. The user validation module 703, specifically the login module 703 will prompt the user for login credentials, and then, upon entry thereof, validate the credentials. After such validation, the remote client 701 will begin communication with the manager 103 transmitting valid login credentials, user id data and user license data from modules 706, 707 for comparison with data stored in the user data module 208 described above. The manager 103 user data module validates the user id data and user license data received from the remote client 701. In other embodiments, it may be preferable to avoid storage of user identification data and user regulated goods license data on the remote device 110, but enter such data for each transaction. Additionally, the data may be entered via the remote client 701 once and transmit the data, securely to the user data module 208 of the manager 103 for storage. In this latter case, other user validation protocols may be used.

Upon user validation, the remote client 701 causes the remote device 110 to execute the vendor module 709 which displays to the user information relating to dispensaries near the remote device 110 and allowing the user to select the product desired. Such vendor information is obtained by the vendor module 709 from the manager 103 vendor data module 209. When the user selects the desired product, the selection is relayed to the manager 103 and the voucher module 704 is called and generates an graphic display of a voucher that electronically displays the same encoded voucher information described above, indicating the validity of the user, the product and amount thereof, and the transaction value. The remote client 701 may also allow the user to print the voucher remotely. Additionally, the payment processor 702 may be called to initiate payment via secure electronic money transfers known in the arts. Alternatively, the user, if purchasing from a mobile device, e.g., a smart phone, may visit the relevant vendor 120, present the virtual voucher, or the printed voucher, to the vendor operator who then may scan the virtual voucher with a scanner 121 configured to detect encoded information from an electronic graphic display. The transaction may then proceed as described above.

In another embodiment, the remote client 701 may be configured to facilitate remote delivery to the user. In such case, the system includes a mobile vendor delivery system 120′, which is a computer-based mobile device, in communication with a mobile scanner 121′, and with the manager 103. When the user completes the transaction and a voucher is generated, remote client 701 sends relevant information to the manager 103 which conveys the information, including product, amount, user location, and transaction price, to the relevant vendor 120. The vendor prepares the product and then dispatches it for delivery with a mobile vendor system 120′ operated by a delivery operator.

Upon delivery the user will present either the virtual voucher or the printed voucher which the delivery operator will scan with the mobile scanner 121′. The mobile vendor system 120′ then transmits the scanned information to the manager 103 for validation as described above. Upon receiving indication that the voucher is valid, the delivery operator may hand the product to the user. Payment for the regulated goods may be facilitated prior to delivery via the payment processor module 701. Additionally, the payment processor may be configured to only require payment information from the user, e.g., credit or debit card information. The payment may be processed by the delivery operator with an appropriately configured mobile vendor delivery system 120′.

As described above and shown in the associated drawings, the present invention comprises a payment processing system and method for purchasing of regulated goods. While particular embodiments have been described, it will be understood, however, that any invention appertaining to the system and method described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. A system for processing the purchase of regulated goods by a user of said regulated goods over a communications network, said system comprising:
a computer-based manager having computer-readable media configured to access one or more of:
a database for storing user validity data relative to users eligible to purchase said regulated goods;
a voucher database for storing data relative to user requests for a voucher;
a database for storing data relative to a plurality of said remote voucher dispensing systems; and
a database for storing data relative to vendors of regulated goods;
a remote, computer-based voucher dispensing system in communication with said manager via said communications network, said voucher-dispensing system comprising:
a payment processor;
a user validation module for retrieving said validity data from said manager; and
a voucher generator for generating vouchers specific to a validated user; and
a computer-based vendor system in communication with said manager via said communications network, said vendor system comprising:
a scanner for retrieving data from a printed voucher dispensed by said voucher dispensing system; and
a verification module in communication with said scanner and configured to retrieve voucher data from said manager; and
an inventory module configured with a database for storing data relative to a vendor inventory of regulated goods.

2. The system of claim 1, wherein said validity data includes at least one of user identity data, data indicating whether a user is eligible to acquire a regulated good, and user regulated goods amount data.

3. The system of claim 2, wherein said manager is configured with a database for storing government data relative to a user of regulated goods.

4. The system of claim 1, wherein said vendor system is a mobile vendor system.

5. The system of claim 4, wherein said validity data includes at least one of user identity data, data indicating whether a user is eligible to acquire a regulated good, and user regulated goods amount data.

6. The system of claim 5, wherein said voucher generating system is a remote client.

7. The system of claim 6, wherein said voucher generating system generates electronic vouchers.

8. The system of claim 1, wherein the voucher generating system generates printed vouchers.

9. The system of claim 8, wherein said validity data includes at least one of user identity data, data indicating whether a user is eligible to acquire a regulated good, and user regulated goods amount data.

10. The system of claim 9, wherein said manager is configured with a database for storing government data relative to a user of regulated goods.

11. A method for processing payment for regulated goods comprising the steps of:
accepting via a remote device input of user validity data from a user;
comparing said user validity data to a database of valid users, said validity data being indicative of a user's eligibility to purchase regulated goods;
accepting user payment via said remote device;
generating a voucher indicating said user has paid for said regulated goods;
retrieving voucher data from said voucher; and
comparing said voucher data to a database of generated vouchers.

12. The method of claim 11, wherein said validity data comprises at least one of user identity data, data indicating whether a user is eligible to acquire a regulated good, and user regulated goods amount data.

13. The method of claim 11, wherein said step of generating a voucher comprises one of generating a printed voucher and generating an electronic voucher.

14. The method of claim 11, wherein said remote device is a remote client installed on a user mobile device.

15. The method of claim 11, wherein said step of retrieving voucher data is performed by a mobile vendor system.

16. The method of claim 11, further comprising the step of:
providing data indicative of a vendor's inventory of such regulated goods to a manager.
